(19) United States
(12) Patent Application Publication
(10) Pub. No.: US 2026/0301452 A1
(43) Pub. Date: Oct. 1, 2026

(54) DOCUMENT MANAGEMENT SYSTEM, NON-TRANSITORY COMPUTER READABLE MEDIUM STORING PROGRAM, AND DOCUMENT MANAGEMENT METHOD

(71) Applicant: FUJIFILM Business Innovation Corp., Tokyo (JP)

(72) Inventors: Shunichi KIMURA, Kanagawa (JP); Masanori SEKINO, Kanagawa (JP)

(73) Assignee: FUJIFILM Business Innovation Corp., Tokyo (JP)

(21) Appl. No.: 19/276,000

(22) Filed: Jul. 22, 2025

(30) Foreign Application Priority Data
Mar. 25, 2025 (JP) 2025-050636

(51) Int. Cl. G06V 30/148; G06V 30/14

(52) U.S. Cl. CPC G06V 30/148; G06V 30/1456

(57) ABSTRACT

A document management system includes: a processor configured to: divide an image text for recognition into minimum units and display a recognition result in a cell for each of the minimum units at a display position in association with a position of the image text; and display a recognition result corrected by a user in an integrated cell obtained by integrating two or more cells.

### CROSS-REFERENCE TO RELATED APPLICATIONS

This application is based on and claims priority under 35 USC 119 from Japanese Patent Application No. 2025-050636 filed Mar. 25, 2025.

### BACKGROUND

### (i) Technical Field

The present invention relates to a document management system, a non-transitory computer readable medium storing a program, and a document management method.

### (ii) Related Art

JP2006-72730A discloses a text recognition apparatus that selects, in a case where in a cutout process in units of one text, recognition of the one text is erroneous, a misrecognized text in response to an instruction from an operator, and corrects the selected text to another text.

JP1993-120472A discloses a technique of displaying, in order to allow an operator to easily find and designate a text with a recognition error by comparing a recognition result text with a text image, at positions corresponding to each line and each text of a sentence scanned by scanning means in display means, a text by a recognized text code output by text code output means and a text by a text pattern extracted by pattern extraction means.

### SUMMARY

As a recognition result of the image text, the image text is divided into a minimum unit, the recognition result is displayed for each minimum unit, and the displayed recognition result may be corrected.

In this case, since a user is forced to perform the correction in the recognized minimum unit, there is a problem in that convenience of the user in the correction is lowed.

Aspects of non-limiting embodiments of the present disclosure relate to a document management system, a non-transitory computer readable medium storing a program, and a document management method that improve convenience for a user in a case of correcting a recognition result of an image text, as compared with a case of correcting the recognition result of the image text only for each recognized minimum unit.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a document management system including: a processor configured to: divide an image text for recognition into minimum units and display a recognition result in a cell for each of the minimum units at a display position in association with a position of the image text; and display a recognition result corrected by a user in an integrated cell obtained by integrating two or more cells.

### BRIEF DESCRIPTION OF THE DRAWINGS

Exemplary embodiment(s) of the present invention will be described in detail based on the following figures, wherein:

FIG. 1 is a diagram illustrating an example of a document management system to which the present exemplary embodiment is applied;

FIG. 2 is a diagram illustrating an example of a hardware configuration of a document management server and a user terminal according to the present exemplary embodiment;

FIGS. 3A and 3B are diagrams describing a prerequisite technique for a correction process on a recognition result to which the present exemplary embodiment is applied;

FIGS. 4A and 4B are diagrams describing the problem in the related art described above in a precondition;

FIGS. 5A and 5B are diagrams describing the problem in the related art in English or the like;

FIG. 6 is a diagram illustrating another recognition example in English or the like;

FIGS. 7A and 7B are diagrams describing the correction process in the present exemplary embodiment;

FIG. 8 is a flowchart illustrating a correction process on a recognition result of an OCR process;

FIG. 9 is a state transition diagram of a cell to which the present exemplary embodiment is applied;

FIGS. 10A and 10B are diagrams describing a cell non-selection state and “(1) non-selection continuation” of a state transition;

FIG. 11 is a diagram describing “(2) single cell selection” of the state transition;

FIG. 12 is a diagram describing “(3) plurality-of-cells selection” of the state transition;

FIG. 13 is a diagram describing “(4) single cell selection continuation” of the state transition;

FIG. 14 is a diagram describing “(5) cell deselection” of the state transition;

FIGS. 15A and 15B are diagrams describing “(6) plurality-of-cells selection” of the state transition;

FIGS. 16A and 16B are diagrams describing “(7) plurality-of-cells selection continuation” of the state transition;

FIG. 17 is a diagram describing “(8) cell deselection” of the state transition;

FIG. 18 is a diagram describing “(9) single cell selection” of the state transition;

FIG. 19 is a diagram describing “(9) single cell selection” of the state transition;

FIG. 20 is a diagram describing “(9) single cell selection” of the state transition;

FIG. 21 is a diagram describing a process of automatically selecting and integrating cells without a user designating a cell as an integration destination;

FIGS. 22A to 22C are diagrams illustrating an example of a method of determining whether or not there is an overlap;

FIGS. 23A to 23D are diagrams describing calculation of an overlap amount;

FIG. 24 is a diagram describing a determination of the overlap amount;

FIG. 25 is a flowchart illustrating a process related to cell integration for automatic selection;

FIGS. 26A and 26B are diagrams describing a size of the cell after the integration;

FIG. 27 is a diagram describing another selection method in manual selection; and

FIG. 28 is a diagram describing a method of deleting a cell after inputting a text.

### DETAILED DESCRIPTION

### Document Management System

Hereinafter, exemplary embodiments of the present invention will be described in detail with reference to the accompanying drawings.

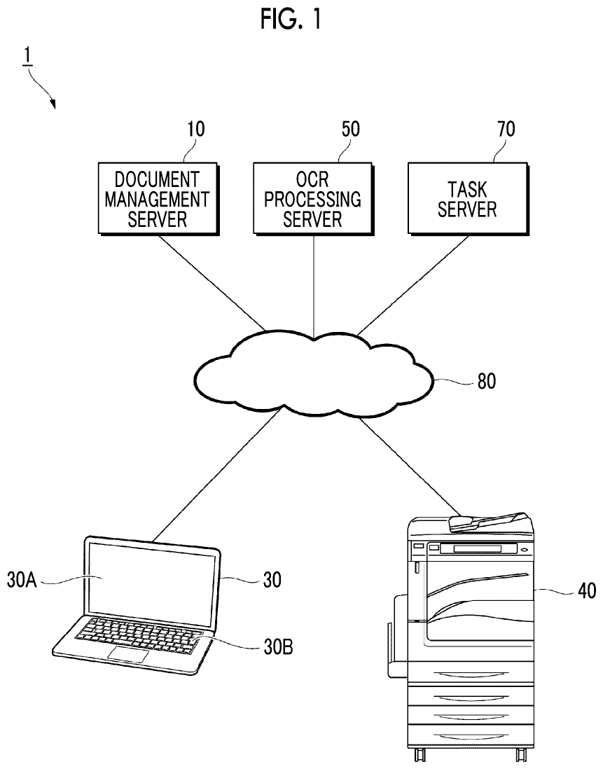

FIG. 1 is a diagram illustrating an example of a document management system to which the present exemplary embodiment is applied.

In a document management system 1, a document management server 10 that manages a document of a user and a user terminal 30 operated by the user are connected via a communication line 80. In addition, an image forming apparatus 40 having an image forming function or an image scanning function of scanning the document and an optical character recognition (OCR) processing server 50 that performs a recognition process on an image text are connected to the communication line 80. In addition, a task server 70 that executes various tasks required by the user is connected to the communication line 80.

The user terminal 30 is an information terminal device used by the user to check a result of an OCR process by the OCR processing server 50 and to correct the recognized text. The user terminal 30 acquires the recognition result of the OCR process by the OCR processing server 50 via the document management server 10. In some cases, the recognition result may be acquired directly from the OCR processing server 50. The user terminal 30 displays the acquired recognition result to the user, and receives an operation for instructing to determine or correct the result of the OCR process, from the user.

The user terminal 30 is provided with a display unit 30A consisting of a liquid crystal display panel, an organic electroluminescence (EL) display panel, or the like for displaying an image, text information, or the like to the user. In addition, an input unit 30B that receives a key input such as a text input or an undo function, a mouse operation, and the like by the user is provided.

For example, a computer apparatus, a tablet information terminal, a smartphone, or other information processing apparatuses are used as the user terminal 30.

The document management server 10 controls the entire document task executed in the document management system 1. The document management server 10 acquires various images such as a form image for recognition from, for example, the user terminal 30 or the image forming apparatus 40, and transmits the images to the OCR processing server 50. Then, the recognition result recognized by the OCR processing server 50 is output to the user terminal 30. In addition, correction for the recognition result of OCR performed on the user terminal 30 is controlled. The correction for the recognition result of OCR may be executed by an application program executed on the user terminal 30.

The OCR processing server 50 recognizes an image text consisting of a handwritten text or the like input for various documents such as a non-standard form or a standard document. Various images to be subjected to the OCR process are acquired from, for example, the document management server 10. In addition to the various images scanned by a scanning device of the image forming apparatus 40, various images may be acquired from the user terminal 30 or may be acquired from the task server 70, other various terminals, or the like via the communication line 80.

The task server 70 receives, for example, the recognition result processed by the OCR processing server 50, and is in charge of performing a specific task under the document management server 10. For example, management of customer information, calculation of expenses, or the like may be performed.

In some cases, the “document management system” of the present case is configured with only the function configuration of the document management server 10 and the user terminal 30. The “document management system” in the present case does not necessarily have all the configuration of the document management system 1 illustrated in FIG. 1, and may have a part of the document management system 1.

### Hardware Configuration

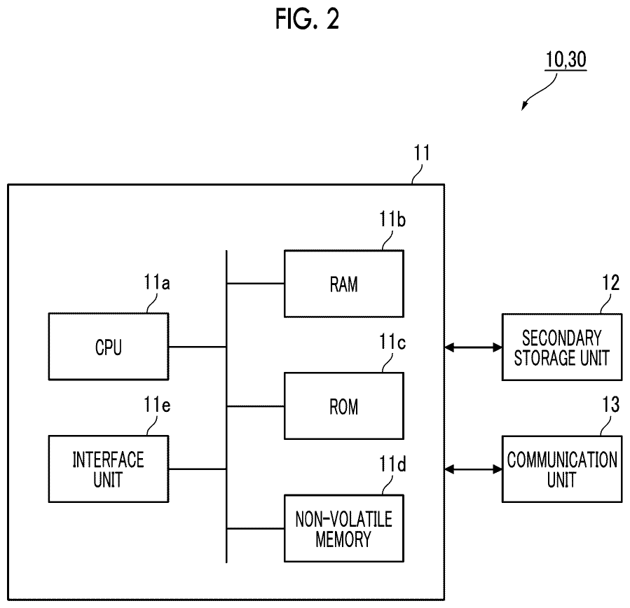

FIG. 2 is a diagram illustrating an example of a hardware configuration of the document management server 10 and the user terminal 30 according to the present exemplary embodiment.

Each apparatus of the document management server 10 and the user terminal 30 according to the present exemplary embodiment includes a control unit 11 that controls an operation of the entire apparatus, a secondary storage unit 12 in which image information and the like including an image text or the like for recognition are recorded, and a communication unit 13 that transmits and receives information via the communication line 80 (see FIG. 1).

The control unit 11, the secondary storage unit 12, and the communication unit 13 are connected to each other through a bus or a signal line. The secondary storage unit 12 is configured with, for example, a hard disk device (HDD), a semiconductor memory, or the like.

The control unit 11 includes a central processing unit (CPU) 11a that controls the entire apparatus as an example of a processor, a RAM 11b that is used as a work memory or the like of the CPU 11a, and a ROM 11c in which a program executed by the CPU 11a and the like are stored. Further, the control unit 11 includes a non-volatile memory 11d that is configured in a rewritable manner and can retain data even in a case where power supply is interrupted, and an interface unit 11e that controls each unit such as a communication unit 13 connected to the control unit 11.

The non-volatile memory 11d is configured with, for example, an SRAM, a flash memory, or the like backed up by a battery. Further, in a case where the control unit 11 reads a program stored in the secondary storage unit 12, each process is executed by each apparatus of the present exemplary embodiment.

In FIG. 2, an example of the document management server 10 and the user terminal 30 is described, but in the present exemplary embodiment, each process is executed by any computer.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

### Precondition in Correction Process on Recognition Result

Next, a precondition for a correction process on a recognition result, which is executed in the present exemplary embodiment will be described.

First, for example, the OCR processing server 50 performs an OCR process on a handwritten text provided from the document management server 10 to the OCR processing server 50. The user terminal 30 acquires a processing result of the OCR process from the document management server 10 or the OCR processing server 50, and displays the processing result on the display unit 30A. The user terminal 30 receives a correction instruction from the user through the input unit 30B for the displayed recognition result, and displays a corrected recognition result on the display unit 30A. The corrected recognition result is transmitted to the document management server 10 via the communication line 80. The document management server 10 can also directly receive a correction instruction from the user through the input unit 30B of the user terminal 30, and perform the correction process.

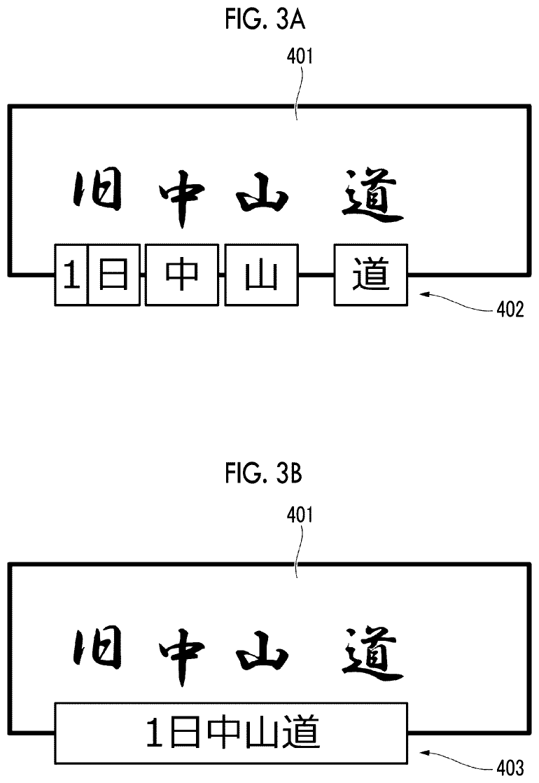

FIGS. 3A and 3B are diagrams describing a prerequisite technique for a correction process on a recognition result to which the present exemplary embodiment is applied. FIG. 3A illustrates an example in which a check field of a recognition result is divided into minimum units, and FIG. 3B illustrates an example in which the check field of the recognition result is represented by a text string. FIG. 3A illustrates a form image 401 which is an image text for recognition and a check field 402 of a recognition result, and FIG. 3B illustrates the form image 401 and a check field 403 of the recognition result.

In FIG. 3A, the image text of the form image 401 is divided into the minimum units, and the OCR result is displayed for each minimum unit by using the check field 402. In the check field 402, a display position of the OCR result is displayed by aligning the display position of the OCR result with a position of the image text. For each text, it is easy to align a position of each text of the form image 401 with a position of each text of the check field 402.

On the other hand, in FIG. 3B, the check field 403 is displayed to include a plurality of texts, instead of being displayed for each text. In a case of a text string, it is difficult to align the position of each text of the form image 401 with a position of each text of the check field 403.

In the present exemplary embodiment, as illustrated in FIG. 3A, the image text is divided into the minimum unit, and the OCR result is displayed for each minimum unit, as a prerequisite technique. By displaying the OCR result for each minimum unit, it is easy to align the position of the text in the form image with the display position of the text in the OCR result. In a case where the entire text string is displayed or the like, for example, as illustrated in FIG. 3B, a text width or a blank width between the texts is automatically determined depending on a font of the texts or OS, other than the minimum unit. Therefore, it is difficult to control the position of each text, which is the minimum unit, to be aligned with the text position of the form image. Therefore, in the present exemplary embodiment, as a precondition, the image text for recognition is divided into the minimum unit, the display position is associated with the position of the image text of the minimum unit, and the recognition result is displayed for each minimum unit.

Here, the “image text” is a text which is present in the image, and is recognized as a text in an image in the OCR process. In addition to the handwritten text, a printed image, a facsimile image, a captured image, and the like are recognized as texts in the OCR process. A text included in an image stored in a file format in which the same state as a printed page is stored, such as a portable document format (PDF), is also included in the “image text”.

### Problems in Related Art in Precondition

Next, a problem in the related art in a case where the prerequisite technique described above is employed will be described.

In the precondition described above, it is necessary to correct each minimum unit (for example, one text), so that the following two problems occur.
(i) In a case where one text is erroneously recognized as two texts, the number of texts cannot be corrected into the correct number of texts.
(ii) In a case where one text is converted into Kanji, it takes time until a target text is displayed as a candidate, and efficiency in correction is lowered.

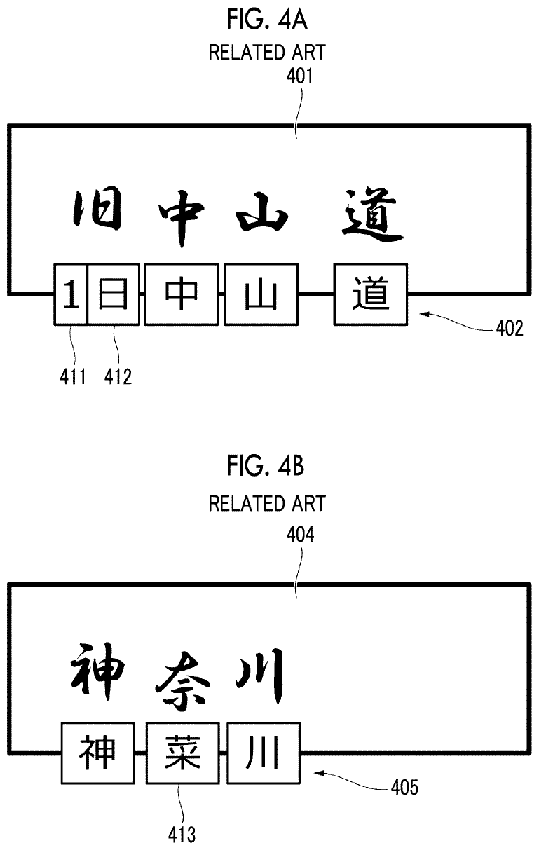

FIGS. 4A and 4B are diagrams describing the problem described above in the related art in the precondition. FIG. 4A illustrates an example of a case where one text is erroneously recognized as two texts, and illustrates the problem (i) described above. In addition, FIG. 4B is a diagram describing inconvenience in a case of inputting a correction text, and is a diagram describing the problem (ii) described above.

In FIG. 4A, the presence of cells 411 and 412 at erroneous recognition locations in the check field 402 of the form image 401 is illustrated. In addition, in FIG. 4B, a cell 413 at the erroneous recognition location, which takes time to be corrected is illustrated in a check field 405 of a form image 404.

In FIG. 4A, in OCR, original one text of “ [symbol] ” is erroneously recognized as two texts of “1” and “ [symbol] ” with the cells 411 and 412 at the erroneous recognition location. In this case, it is difficult to easily correct the number of texts into one correct text.

On the other hand, in FIG. 4B, in the cell 413 at the erroneous recognition location, “ [symbol] ”, which is erroneously recognized, is to be originally recognized as “ [symbol] ”. In this case, in a case where “ [symbol] ” is input by designating the cell 413 and conversion into Kanji with one text is attempted, it takes a long time to reach “ [symbol] ”. That is, in a case where one text is converted into Kanji, it takes time until a target text is displayed as a candidate. In a case of Kanji, it is easier to perform conversion by inputting each compound word than performing conversion by one-text conversion. In this example, it is more convenient for the user to input a compound word “ [symbol] ” as a whole.

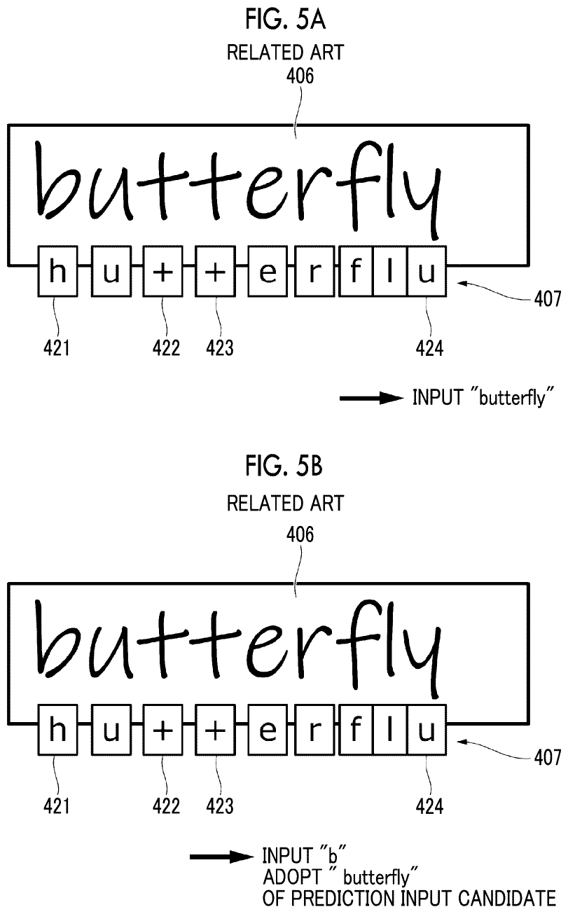

FIGS. 5A and 5B are diagrams describing the problem in the related art in English or the like. FIG. 5A illustrates an example of an input by an English key puncher, and FIG. 5B illustrates an example of a case where a prediction input function is provided. The same is applied to languages other than English. In FIGS. 5A and 5B, erroneous recognition occurs at cells 421 to 424 in a check field 407 of a form image 406. In FIGS. 5A and 5B, one text of “butterfly” is erroneously divided into a plurality of texts.

In a case of FIG. 5A, it is faster to input each word than to select and correct each cell. In general, the key puncher is accustomed to inputting in word units. That is, it is faster to type “butterfly” than to select the cell 421 erroneously recognized as “h” and type “b”, to select the cells 422 and 423 erroneously recognized as “+” and type “t”, and to select the cell 424 erroneously recognized as “u” and type “y”.

In FIG. 5B, in a case of using the prediction input function, it may be faster to input each word at once than to select and correct each cell. For example, a case where a word of “butterfly” is input in the past or a case where the word of “butterfly” is a regular word is considered. In this case, since a prediction input candidate of “butterfly” is presented at a stage at which a first text (for example, “b”) is input, the user may select the prediction input candidate. That is, it is faster to input “b” and select “butterfly” than to select the cell 421 erroneously recognized as “h” and type “b”, select the cells 422 and 423 erroneously recognized as “+” and type “t”, and select the cell 424 erroneously recognized as “u” and type “y”.

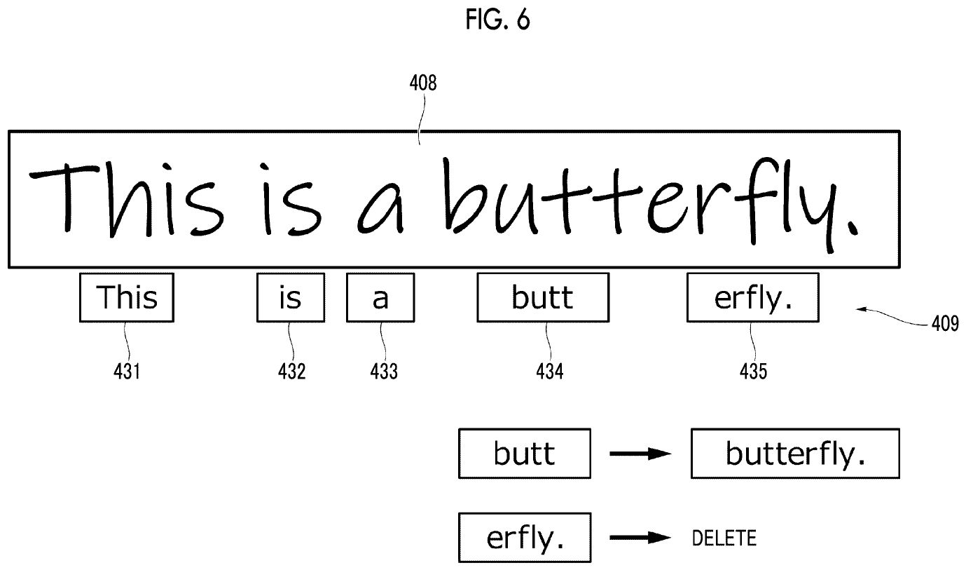

FIG. 6 is a diagram illustrating another recognition example in English or the like. Here, a check field 409 is output as a recognition result of a form image 408 written in English. In English or the like, the minimum unit may be a word, and in this case, it is assumed that there is a space between the minimum units. An output text string is obtained by inserting a space between the minimum units (for example, between words).

In the example illustrated in FIG. 6, the recognition result of a cell 431 of “This”, a cell 432 of “is”, a cell 433 of “a”, a cell 434 of “butt”, and a cell 435 of “erfly.” is displayed, for each minimum unit. The output text string is “This is a butt erfly.”. The recognition result is displayed by associating a display position with a position of an image text.

Here, for example, a case where one word is erroneously recognized as two words, such as the cell 434 of “butt” and the cell 435 of “erfly.”, is considered. In this case, although it may be possible to perform correction only by integrating the minimum units, two steps of correction for one cell and deletion of the other cell are required to perform the correction. That is, in order to perform the correction, it is necessary to perform two steps of first selecting the cell 434 of “butt” and correcting the cell 434 of “butt” into “butterfly”, and then selecting and deleting the cell of the cell 435 of “erfly.”.

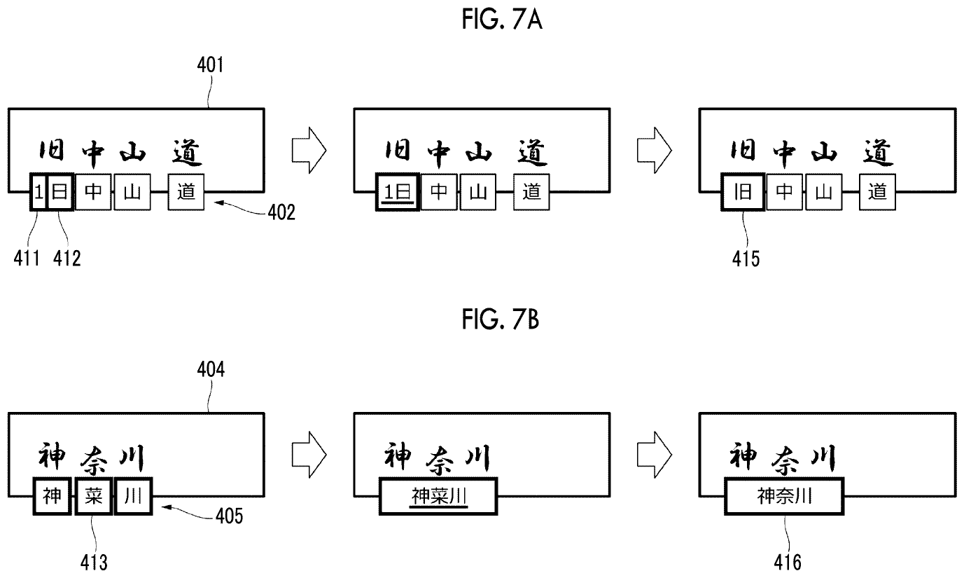

FIGS. 7A and 7B are diagrams describing a correction process according to the present exemplary embodiment. FIG. 7A illustrates an input example for a first erroneous recognition example, and FIG. 7B illustrates an input example for a second erroneous recognition example. Here, it is possible to input and integrate a plurality of cells.

In FIG. 7A, in the check field 402 of the form image 401, the cells 411 and 412 that are erroneously recognized are selected, and a text of “ [symbol] ”, which is a correction text, is input by a key input by the user. Then, the correction is performed such that the input content of the text of “ [symbol] ” is reflected in an integrated cell 415 obtained by integrating the cells 411 and 412 which are consecutive cells. In this manner, in the present exemplary embodiment, for example, in a case where one text is erroneously recognized as two texts or the like, correction into the correct number of texts can be performed.

In FIG. 7B, the cell 413 erroneously recognized as “ [symbol] ” is selected in the check field 405 of the form image 404, and a text of “ [symbol] ”, which is a correction text, is input by a key input by the user. Then, the correction is performed such that the input content of the text of “ [symbol] [symbol] ” is reflected in an integrated cell 416 obtained by integrating the adjacent cells. In this manner, in the present exemplary embodiment, for example, the problem that it takes time for a target text to be displayed as a candidate in correction in a case of converting one text is easily addressed.

### Correction Process on Recognition Result

Next, a correction process on a recognition result of an OCR process in the present exemplary embodiment will be described.

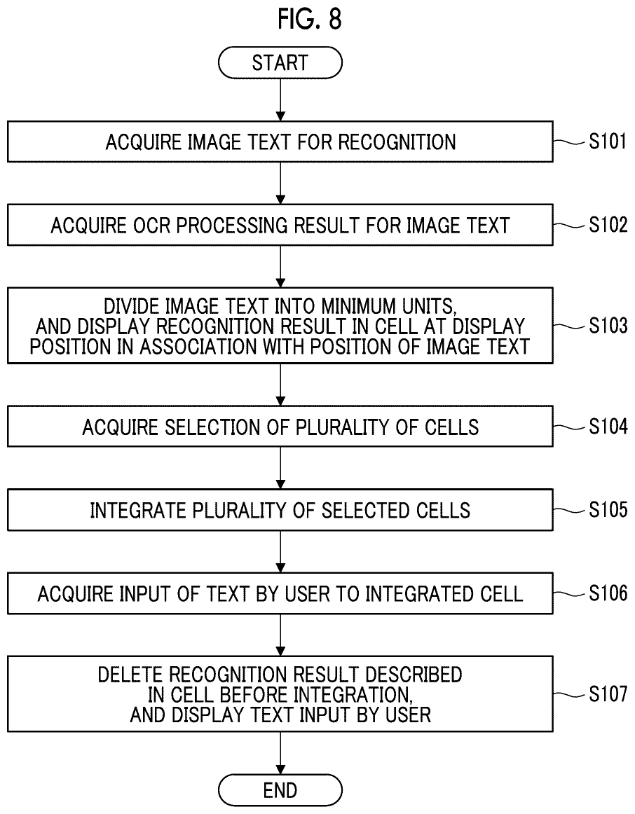

FIG. 8 is a flowchart illustrating the correction process on the recognition result of the OCR process. The process illustrated in FIG. 8 is mainly executed by the document management server 10 and/or the control unit 11 of the user terminal 30.

First, the control unit 11 acquires an image text for recognition (step S101). In addition, the control unit 11 acquires an OCR processing result for the image text (step S102). The OCR processing result is, for example, a processing result obtained by the OCR processing server 50. Thereafter, the control unit 11 divides the image text into minimum units, and displays the recognition result in a cell at a display position in association with a position of the image text (step S103). More specifically, the recognition result is displayed on the display unit 30A of the user terminal 30. As an example of associating the display position, for example, the image text is disposed on an upper part and the recognition result is displayed in a cell below the upper part by being aligned with a position of each text of the image text, and the like.

Thereafter, the control unit 11 acquires selection of a plurality of cells (step S104). An example of acquiring the selection is a case where a user clicks and selects all cells to be integrated via the input unit 30B of the user terminal 30. In addition, for example, there is an aspect in which the user only selects one cell and inputs a text to be corrected, and the cell to be selected is automatically selected, and the selection of the plurality of cells is acquired.

Then, the control unit 11 integrates the plurality of selected cells (step S105). Thereafter, the control unit 11 acquires an input of a text by the user to an integrated cell obtained by integrating the plurality of cells (step S106). More specifically, the input unit 30B of the user terminal 30 receives the input of the correction text as a result of a key input by the user. After receiving the input, the recognition result described in the cell before the integration is deleted, and the text input by the user is displayed on the display unit 30A of the user terminal 30 (step S107).

Here, the “cell” is a work space on a screen that is used to display the recognition result of the OCR process and to correct the displayed recognition result. For example, a form in which the recognition result is surrounded by a rectangular frame, a form in which the recognition result is represented by a rectangular color region, and the like can be used. In addition, the “cell” can be a transparent space for work. In addition, there is an aspect in which the display is not in a rectangular shape. In this “cell”, it is possible to delete, input, add, and the like a text, and each cell has these functions.

The aspect in which the recognition result is displayed as a “cell” can be understood as a region of a function as a “cell”. Therefore, even in a case where the “cell” is not displayed in a visible form as a form, in a case where the recognition result (OCR text) is displayed in a region of the function as the cell, it can be said that the “recognition result is displayed in cell” in the present exemplary embodiment.

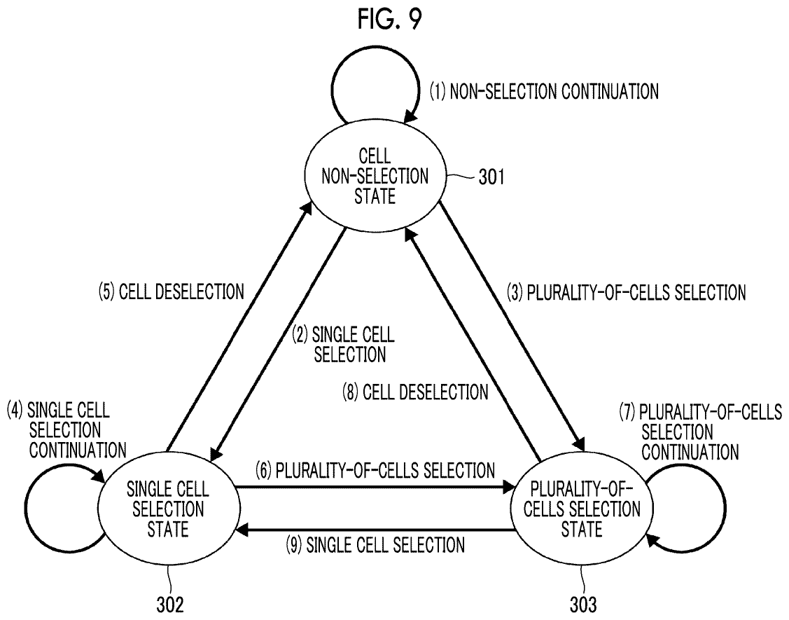

FIG. 9 is a state transition diagram of a cell to which the present exemplary embodiment is applied. There are three selection states for the cell on an UI. A cell non-selection state 301 in which no cell is selected, a single cell selection state 302 in which only one cell is selected, and a plurality-of-cells selection state 303 in which a plurality of cells are selected. Each of the three transition states corresponds to an event generated on a graphical user interface (GUI), and each state transition is generated. As a state transition between these three selection states, there are operations of (1) non-selection continuation, (2) single cell selection, (3) plurality-of-cells selection, (4) single cell selection continuation, (5) cell deselection, (6) plurality-of-cells selection, (7) plurality-of-cells selection continuation, (8) cell deselection, and (9) single cell selection.

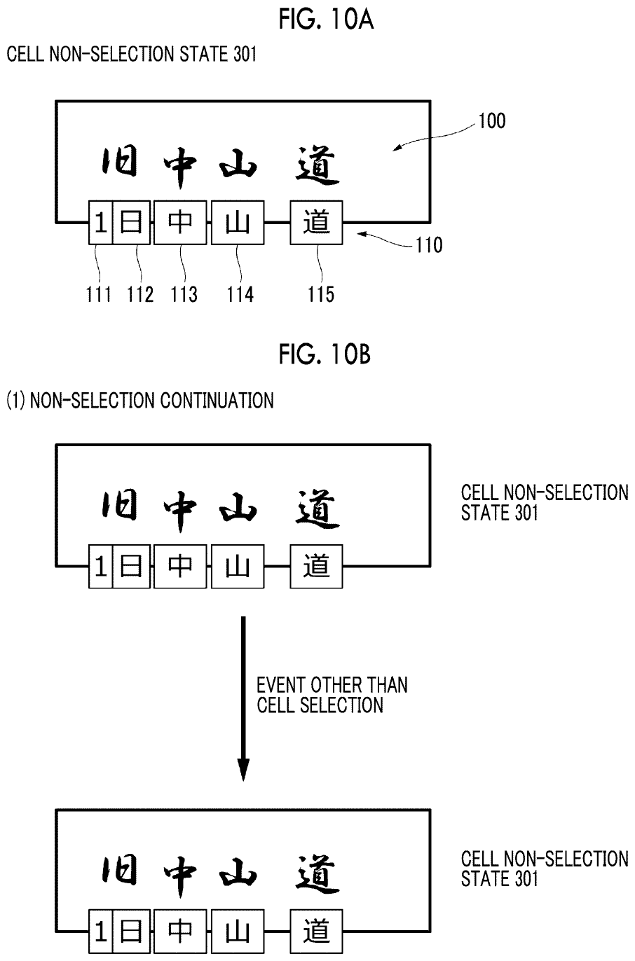

Next, each operation of the state transition will be described with reference to FIGS. 10 to 20.

FIGS. 10A and 10B are diagrams describing the cell non-selection state 301 and “(1) non-selection continuation” of the state transition. FIG. 10A illustrates the cell non-selection state 301, and FIG. 10B illustrates a state transition of “(1) non-selection continuation”.

Here, as illustrated in FIG. 10A, a check field 110, which is a recognition result of an OCR process, is formed for an image text 100 for recognition as an example of the cell non-selection state 301. In the check field 110, cells 111 to 115 are formed by associating a display position with a position obtained by dividing the image text by a minimum unit. OCR texts, which are recognition results of the OCR process on the image text, are displayed in the cells 111 to 115.

Here, the cell is displayed by associating the display position with the position of the image text to reduce movement of the user's line of sight and make it easy to check, by bringing the image text and the result of the OCR process closer to each other. In order to align the display position, it is assumed that positional information on each text is grasped, during the OCR process. In the example in FIG. 10, in OCR, a position recognized as a text of “1” and a position recognized as a text of “ [symbol] ” are recognized, the cell 111 is formed corresponding to the text of “1”, and the cell 112 is formed corresponding to the text of “ [symbol] ”. In a case where in the OCR, “ [symbol] ” is recognized as one text, there is no recognition result for the position of “1” and the position of “ [symbol] ”.

Here, the “minimum unit” of the image text is a unit as a result of the OCR process. For example, one text in a case of Japanese or one group of alphabets (for example, one word or the like) in a case of a language of alphabet notation such as English is included. This unit also includes an erroneous recognition result and the like by the OCR process.

In the normal OCR process, a text-rectangular position for each text is often output. Meanwhile, in a case of alphabet notation such as English, the text-rectangular position is not output for each alphabet, and is often output as one block for each word in English. In this case, in the normal OCR process, positional information on the word is known, but positional information on each alphabet is not known. In a case where the positional information is not known, a position in the image and a position of the text cannot be output together, and in the OCR process of English or the like, only a position of the word can be aligned. In the OCR recognition in the alphabet notation such as English, in a case where the recognition result is displayed for each word, there is a case where a word that is actually one word is erroneously displayed as two words. In the example illustrated in FIG. 6, an aspect in which “butterfly.” is originally recognized as one word, but is erroneously displayed as two words of “butt” and “erfly.” may be considered. Therefore, in the present exemplary embodiment, a delimiter of the image text for recognition is set as a “minimum unit” instead of a “word”, and a unit for position alignment is made consistent between Japanese and foreign languages such as English.

FIG. 10B illustrates a case where “event other than cell selection” is generated as “(1) non-selection continuation”. In this case of the “event other than cell selection”, the cell non-selection state 301 is continued. For example, clicking (selecting) a portion other than a cell with a mouse is this “event other than cell selection”.

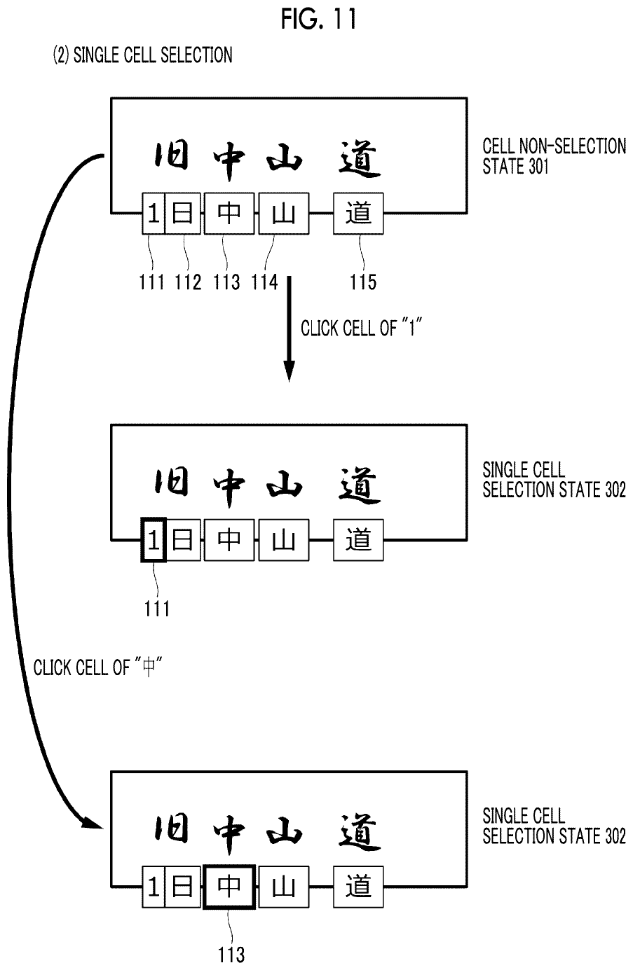

FIG. 11 is a diagram describing “(2) single cell selection” of the state transition. In the cell non-selection state 301, by clicking the cell 111 of “1” with a mouse, a transition is made to a state in which only the cell 111 of “1” is selected. This state is the single cell selection state 302. The state transition is generated even in a case where any one of the other cells 112 to 115 is clicked. For example, by clicking the cell 113 of “ [symbol] ” with a mouse, a transition is made to the single cell selection state 302 in which only the cell 113 of “ [symbol] ” is selected. In the single cell selection state 302, the selected cells 111 and 113 are highlighted individually in each state by, for example, a thick line, a colored line, or the like. In this manner, a state in which only one cell (for example, the cell 111 or the cell 113) is selected is the single cell selection state 302. In a case where the number of selected cells is one, regardless of which of the cells 111 to 115 is selected, the single cell selection state 302 is set.

Here, for example, it is also possible to set an initial state to the single cell selection state 302. For example, the single cell selection state 302 in which the leftmost cell 111 is selected as illustrated in a middle part of FIG. 11 can be set as the initial state.

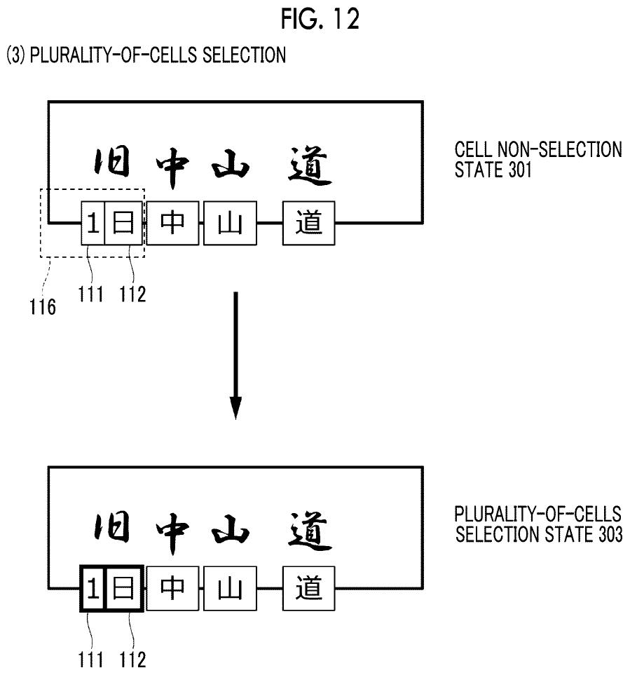

FIG. 12 is a diagram describing “(3) plurality-of-cells selection” of the state transition. In the cell non-selection state 301, by designating a rectangle including the cell 111 of “1” and the cell 112 of “ [symbol] ” as illustrated in a dotted line 116 in FIG. 12 with a mouse, a transition to the plurality-of-cells selection state 303 is made. In the plurality-of-cells selection state 303, the cell 111 of “1” and the cell 112 of “ [symbol] ” are selected and highlighted.

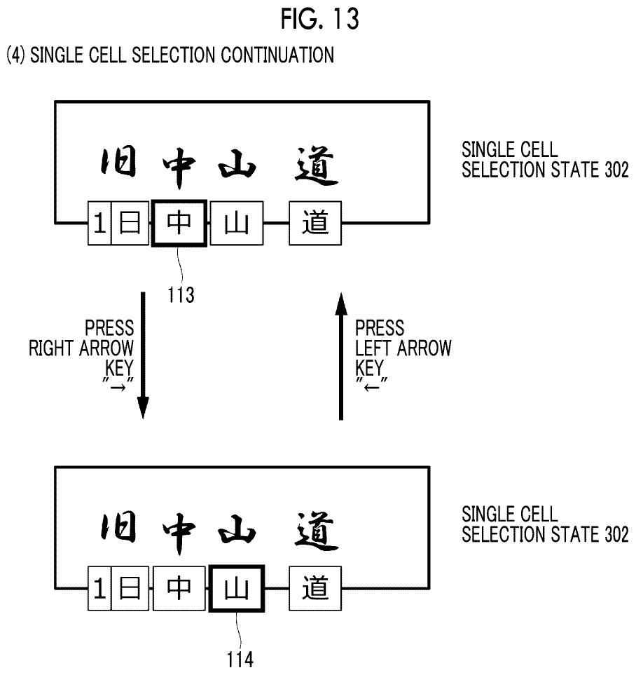

FIG. 13 is a diagram describing “(4) single cell selection continuation” of the state transition. Here, an example of a single cell selection continuation event that is generated in the single cell selection state 302 is illustrated. For example, in a case where a right arrow key “→” is pressed, one right cell is selected, in a case where a left arrow key “←” is pressed, one left cell is selected, and the single cell selection state 302 is continued.

For example, in the single cell selection state 302 in which only the cell 113 of “ [symbol] ” is selected, in a case where the right arrow key “→” is pressed, the single cell selection state 302 in which the cell 114 of “ [symbol] ” which is one right cell is selected is obtained. In this case, the single cell selection state 302 is continued. In addition, for example, in the single cell selection state 302 in which only the cell 114 of “ [symbol] ” is selected, in a case where the left arrow key “←” is pressed, the single cell selection state 302 in which the cell 113 of “ [symbol] ” which is one left cell is selected is obtained. Even in this case, the single cell selection state 302 is continued.

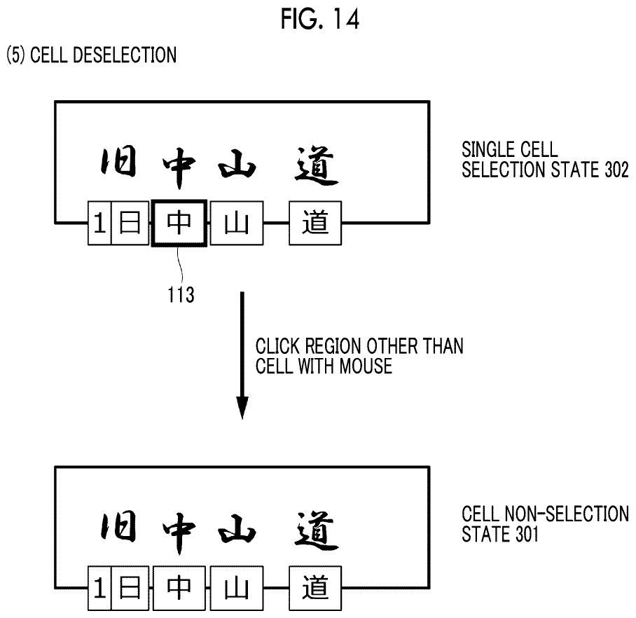

FIG. 14 is a diagram describing “(5) cell deselection” of the state transition. In an upper part of FIG. 14, first, a state in which one cell 113 of “ [symbol] ” is selected in the single cell selection state 302 is illustrated. Here, in a case where an event other than cell selection is executed, a transition is made to the cell non-selection state 301. For example, by clicking a region other than the cells with a mouse, a transition is made to the cell non-selection state 301 illustrated in a lower part of FIG. 14.

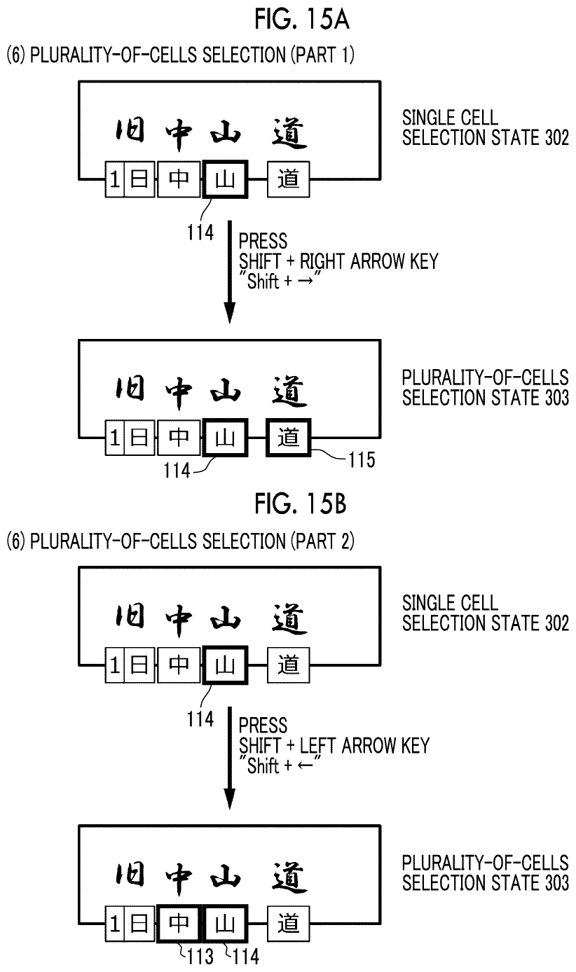

FIGS. 15A and 15A are diagrams describing “(6) plurality-of-cells selection” of the state transition.

In FIG. 15A, as (6) plurality-of-cells selection (part 1) of the state transition, an example (part 1) of a transition event from the single cell selection state 302 to the plurality-of-cells selection state 303 is illustrated. In a case where a shift key+a right arrow key “Shift+→” is pressed in the single cell selection state 302 in which only one cell is selected, one right cell is additionally selected. In an upper part of FIG. 15A, the single cell selection state 302 in which the cell 114 of “ [symbol] ” is selected is set. In a case where “Shift+→” is pressed at this time, a state in which the cell 115 of “ [symbol] ” is additionally selected as illustrated in a lower part of FIG. 15A is obtained. That is, the plurality-of-cells selection state 303 in which a plurality of cells of the cell 114 of “ [symbol] ” and the cell 115 of “ [symbol] ” are selected is obtained.

FIG. 15B illustrates the example (part 2) of the transition event from the single cell selection state 302 to the plurality-of-cells selection state 303 as (6) plurality-of-cells selection (part 2) of the state transition. In a case where a shift key+a left arrow key “Shift+←” is pressed in the single cell selection state 302 in which only one cell is selected, one left cell is additionally selected. In an upper part of FIG. 15B, the single cell selection state 302 in which the cell 114 of the “ [symbol] ” is selected is set. In a case where “Shift+←” is pressed at this time, a state in which the cell 113 of “ [symbol] ” is additionally selected as illustrated in a lower part of FIG. 15B is obtained. That is, the plurality-of-cells selection state 303 in which a plurality of cells of the cell 113 of “ [symbol] ” and the cell 114 of “ [symbol] ” are selected is obtained.

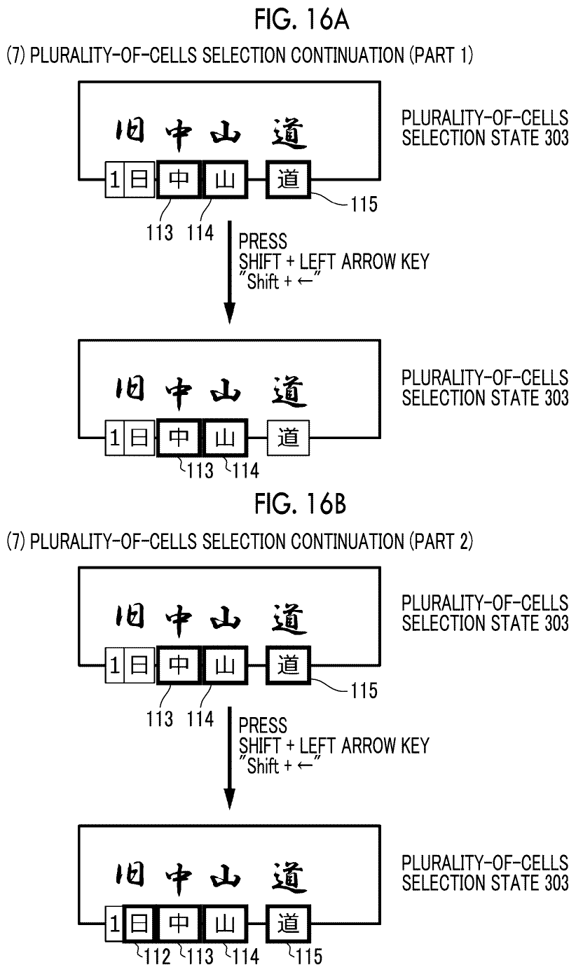

FIGS. 16A and 16B are diagrams describing “(7) plurality-of-cells selection continuation” of the state transition.

Here, the plurality-of-cells selection state 303 includes a case where three or more cells are selected, in addition to a case where two cells are selected. For example, as illustrated in a lower part of FIG. 16A, a state in which two cells of the cell 113 of “ [symbol] ” and the cell 114 of “ [symbol] ” are selected is the plurality-of-cells selection state 303. In addition, for example, as illustrated in FIG. 16B, the plurality-of-cells selection state 303 is also set in a case where three or more cells are selected. In an upper part of FIG. 16B, three cells of the cell 113 of “ [symbol] ”, the cell 114 of “ [symbol] ”, and the cell 115 of “ [symbol] ” are selected, and even in this case, the plurality-of-cells selection state 303 is set. In addition, as illustrated in a lower part of FIG. 16B, even in a case where four cells 112 to 115 are selected, the plurality-of-cells selection state 303 is set. In this manner, the plurality-of-cells selection state 303 is a state in which two or more cells are selected.

FIG. 16A illustrates a first example in which the plurality of cells are consecutively selected as (7) plurality-of-cells selection continuation (part 1) of the state transition.

In the example of the plurality-of-cells selection state 303 in an upper part of FIG. 16A, a cell selected as a single cell first is referred to as the cell 113 of “ [symbol] ”. In addition, a cell that is additionally selected last is set as the cell 115 of “ [symbol] ”, and the number of selected cells is set to three or more. In this case, the cell 115 of “ [symbol] ” is deselected by pressing a shift key+a left arrow key “Shift+←”. As illustrated in the lower part of FIG. 16A, since a plurality of cells are selected even in a case where the cell 115 of “ [symbol] ” is deselected, the plurality-of-cells selection state 303 is continued.

FIG. 16B illustrates a second example in which the plurality of cells are consecutively selected as (7) plurality-of-cells selection continuation (part 2) of the state transition.

In the example of the plurality-of-cells selection state 303 in an upper part of FIG. 16B, a cell selected as a single cell first is referred to as the cell 115 of “ [symbol] ”. In addition, a cell that is additionally selected last is the cell 113 of “ [symbol] ”. In this case, the cell 112 of “ [symbol] ” is additionally selected by pressing a shift key+a left arrow key “Shift+←”. As illustrated in the lower part of FIG. 16B, since a plurality of cells are selected even in a case where the cell 112 of “ [symbol] ” is additionally selected, the plurality-of-cells selection state 303 is continued.

In the examples illustrated in FIGS. 16A and 16B, the example of pressing a shift key+a left arrow key “Shift+←” is illustrated, but the same is applied to a case of pressing the shift+right arrow key “Shift+→” in a case where a target operation is considered.

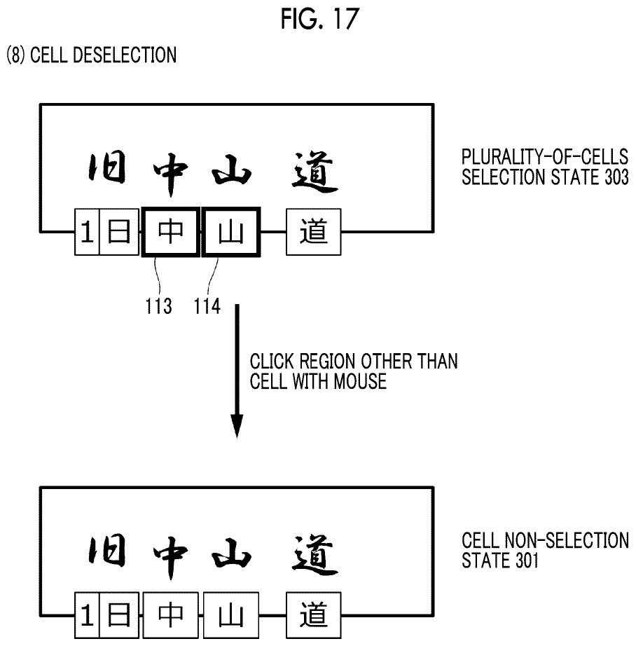

FIG. 17 is a diagram describing “(8) cell deselection” of the state transition. Here, a transition is made from the plurality-of-cells selection state 303 to the cell non-selection state 301. In an upper part of FIG. 17, a state in which the cell 113 of “ [symbol] ” and the cell 114 of “ [symbol] ” are selected in the plurality-of-cells selection state 303 is illustrated. Here, in a case where an event other than cell selection is executed, a transition is made to the cell non-selection state 301. For example, by clicking a region other than the cells with a mouse, a transition is made to the cell non-selection state 301 illustrated in a lower part of FIG. 17.

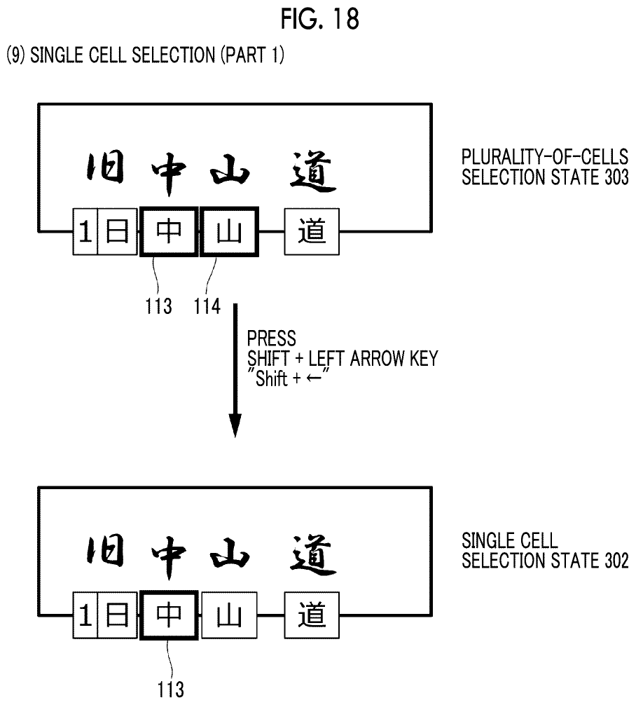

FIGS. 18 to 20 are diagrams describing “(9) single cell selection” of the state transition.

FIG. 18 illustrates an example of a simple transition from the plurality-of-cells selection state 303 to the single cell selection state 302, instead of the transition to the integrated cell, as (9) single cell selection (part 1) of the state transition.

It is assumed that the cell 113 of “ [symbol] ” is selected as a first single cell. In addition, the number of selected cells is set to two. In this case, by pressing a shift key+a left arrow key “Shift+←”, the cell 114 of “ [symbol] ” is deselected. By excluding the cell 114 of “ [symbol] ” from the selection, the single cell selection state 302 in which only the cell 113 of the “ [symbol] ” is selected is obtained. Here, although an example of pressing a shift key+a left arrow key “Shift+←” is described, the same is applied to a case of pressing the shift+right arrow key “Shift+→” in considering a target operation.

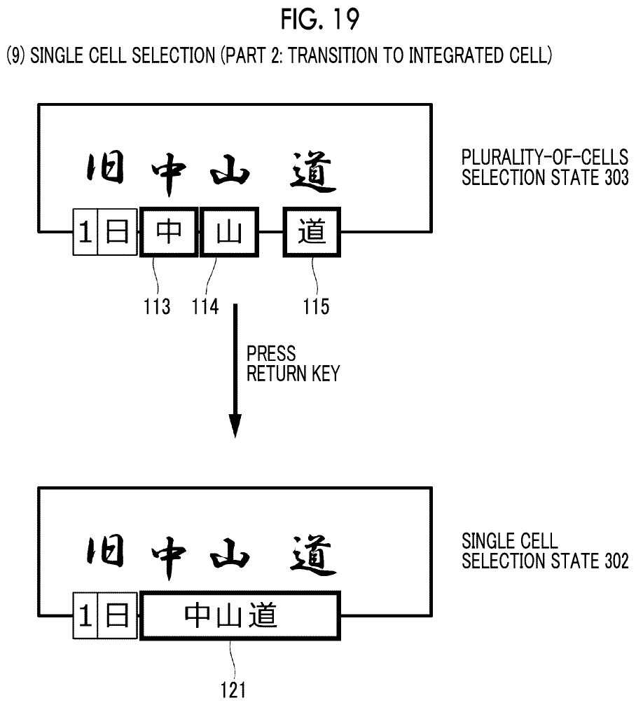

FIG. 19 illustrates an example of a transition from the plurality-of-cells selection state 303 to the single cell selection state 302 by a transition to an integrated cell, as (9) single cell selection (part 2) of the state transition.

As illustrated in an upper part of FIG. 19, it is assumed that three cells of the cell 113 of “ [symbol] ”, the cell 114 of “ [symbol] ”, and the cell 115 of “ [symbol] ” are selected, and the plurality-of-cells selection state 303 is set. In this case, by pressing a return key, the three cells are converted into a single cell as an integrated cell 121, and a transition is made to the single cell selection state 302 in a lower part of FIG. 19. Texts in the integrated cell 121 which is a single cell are a text string obtained by combining three texts. The integrated text string of “ [symbol] ” can be edited as a normal text string. Here, although the example in which the return key is a cell integration key is described, another key can be used as the cell integration key.

In this manner, in a case where the plurality of cells are selected by the user, the selected adjacent cells are integrated to form the integrated cell 121. Then, a text input by the user to the integrated cell 121 is received, and the text input by the user is displayed in the integrated cell 121.

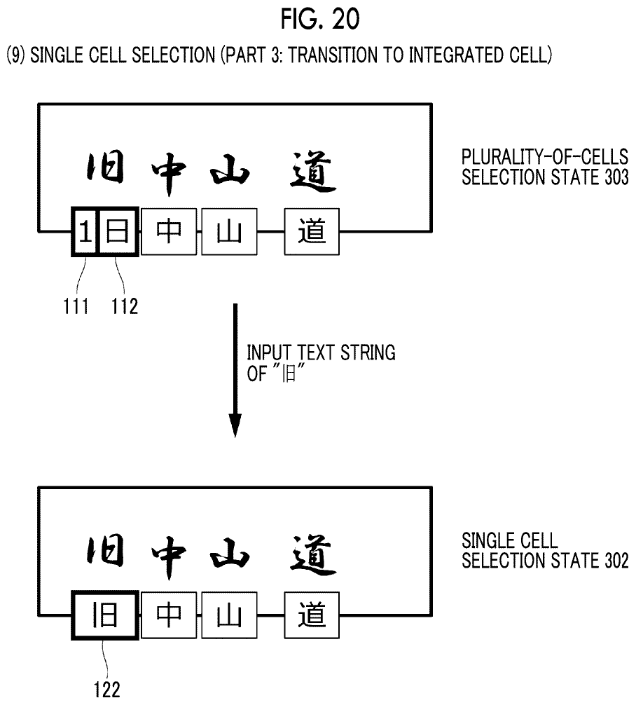

FIG. 20 illustrates another example of the transition from the plurality-of-cells selection state 303 to the single cell selection state 302 by the transition to the integrated cell as (9) single cell selection (part 3) of the state transition.

As illustrated in an upper part of FIG. 20, it is assumed that two cells, that is, the cell 111 of “1” and the cell 112 of “ [symbol] ” are selected, and the plurality-of-cells selection state 303. In a case where an input of a text string is executed at this time, the two cells are integrated and converted into a single cell as the integrated cell 122, and a transition is made to the single cell selection state 302 in a lower part of FIG. 20. The texts in the integrated cell 122 are changed to the input text string. For example, in a case where a text string “ [symbol] ” is input, the text string in the integrated cell is “ [symbol] ”.

In this manner, in a case where the user manually selects cells and performs a key input, the cells (cell 111 and cell 112) are automatically integrated, and the content input by the user is displayed in the integrated cell 122. The operation of the return key or the like illustrated in the example in FIG. 19 is not necessary, the cells are implicitly integrated, and the input can be implicitly started. It is possible to perform correction work without the operation of the user to integrate the cells.

### Automatic Selection

Next, automatic selection in which a user does not designate a cell will be described.

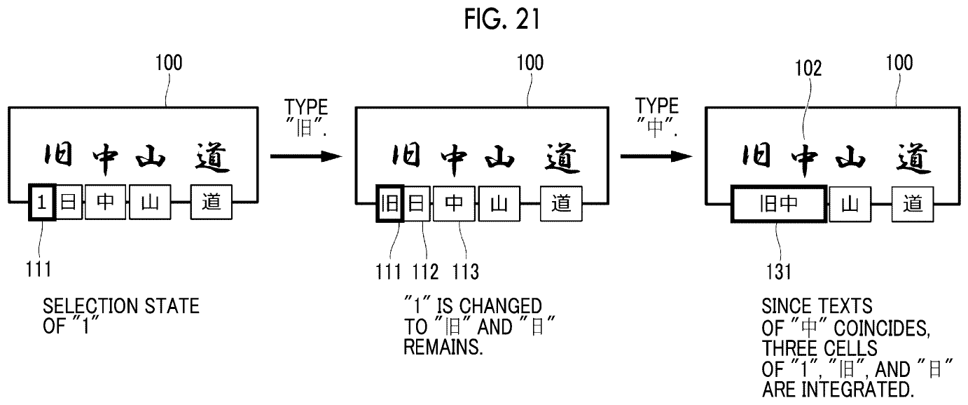

FIG. 21 is a diagram describing a process of automatically selecting and integrating cells without the user designating a cell as an integration destination. Here, a text input is performed, and the cells are automatically integrated. For example, the cell 111 of “1” is selected, and an input of a text of “ [symbol] ” is performed. In this case, in a case where “ [symbol] ” is first input, the cell 111 of “1” is changed to “ [symbol] ”, and at this time, the cell 112 remains as “ [symbol] ”. Then, in a case where “ [symbol] ” is input, the text 102 of “ [symbol] ” in the image text 100 and the input text of “ [symbol] ” coincide with each other. Therefore, three cells of the cell 111 of “1”, the cell 112 of “ [symbol] ”, and the cell 113 of “ [symbol] ” are automatically integrated, and “ [symbol] ” is displayed in the integrated cell 131.

Here, there is a risk of erroneous integration in a case where the texts happen to coincide with each other, for example, with a simple determination as to whether or not the texts coincide with each other or the like. Therefore, for example, in a case where a text position estimated from the number of texts×text width and a text position of in the image text 100 approximately coincide with each other, the texts can be integrated.

As a method of estimating the text width, the following method is provided.

As a precondition, a bounding rectangle of each OCR text for an image is acquired. For example, information on a bounding rectangle as illustrated below is acquired for each of the OCR texts “1”, “ [symbol] ”, and “ [symbol] ”. In each of the OCR texts, (X, Y) is a coordinate value of an upper left pixel of the bounding rectangle, W is a width of the bounding rectangle, and H is a height of the bounding rectangle.
“1”: X1, Y1, W1, H1
“ [symbol] ”: X2, Y2, W2, H2
“ [symbol] ”: X3, Y1, W3, H3

It is assumed that Z is an estimated value of a text width, A is a width of a bounding rectangle of an OCR text string, and B is the number of OCR texts, the text width is estimated as Z=A/B.

The text width estimation may be performed by another method. For example, it is assumed that a height of the bounding rectangle of the OCR text string is C, Z=A/C may be set.

Then, a presence position of the X coordinates of the n-th text obtained by OCR: Xn to Xn+Wn and an estimated text position of the X coordinates of the input n-th text: Z×(n−1) to Z×n are compared with each other. In a case where the two X coordinates overlap with each other, the first text to the n-th text are integrated.

Here, the overlap of the two X coordinates will be considered.

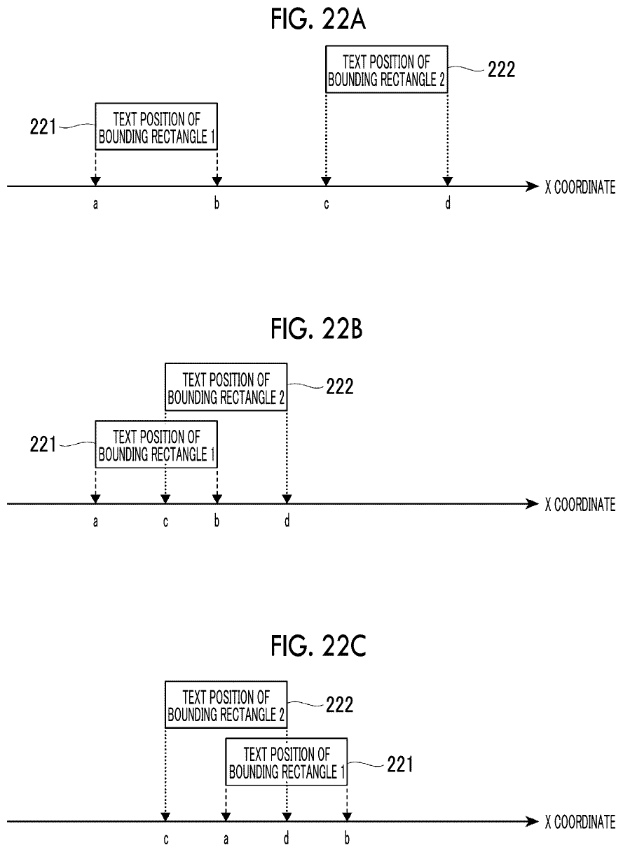

FIGS. 22A to 22C are diagrams illustrating an example of a method of determining whether or not there is an overlap.

Here, a positional relationship of X coordinates between a text position 221 of a bounding rectangle 1 and a text position 222 of a bounding rectangle 2 is illustrated. The text position 221 of the bounding rectangle 1 has X coordinates a to b, and the text position 222 of the bounding rectangle 2 has X coordinates c to d.

In FIG. 22A, there is no overlap between a to b and c to d.

In FIG. 22B, among the X coordinates c to d of the text position 222 of the bounding rectangle 2, c is present between the X coordinates a and b of the text position 221 of the bounding rectangle 1, and there is an overlap. The relationship of a<c<b is obtained.

In FIG. 22C, among the X coordinates c to d of the text position 222 of the bounding rectangle 2, d is present between the X coordinates a and b of the text position 221 of the bounding rectangle 1, and there is an overlap. The relationship of a<d<b is obtained.

In this manner, in a case where the X coordinate of the text position 221 is set to a to b and the X coordinate of the text position 222 is set to c to d, it can be determined that there is an overlap in a case where a<c<b or a<d<b.

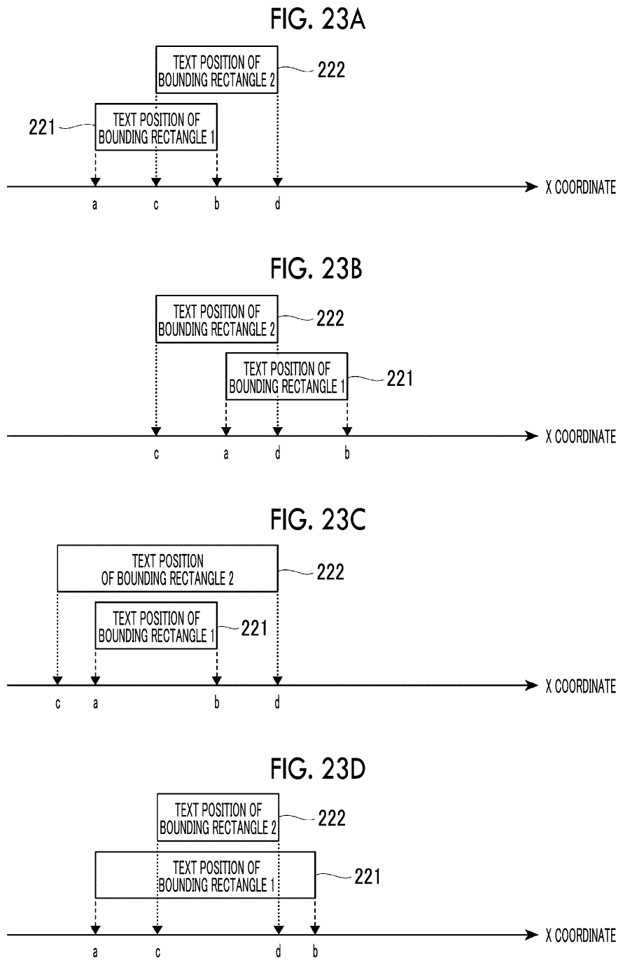

FIGS. 23A to 23D are diagrams describing calculation of an overlap amount. In a case where it is determined that there is an overlap between the X coordinates a and b of the text position 221 of the bounding rectangle 1 and the X coordinates c and d of the text position 222 of the bounding rectangle 2, the overlap amount is determined.

In FIG. 23A, the overlap amount on X-axis is b−c.

In FIG. 23B, the overlap amount on X-axis is d−a.

In FIG. 23C, the overlap amount on X-axis is b−a.

In FIG. 23D, the overlap amount on X-axis is d−c.

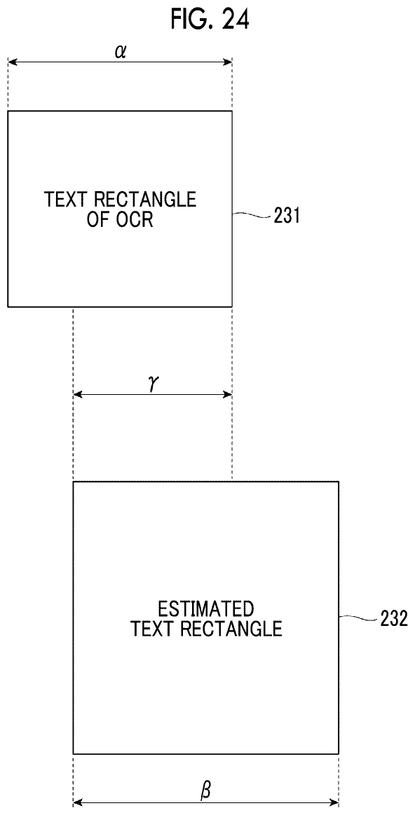

FIG. 24 is a diagram describing a determination of the overlap amount. FIG. 24 illustrates a text rectangle 231 of OCR and an estimated text rectangle 232. A dimension α is a width of the text rectangle 231 of OCR. In addition, a dimension β is an estimated width of the text rectangle 232 of a text input by a user. A dimension γ indicates an overlap amount between the text rectangle 231 of OCR and the estimated text rectangle 232.

Here, as a method of determining whether or not the texts overlap with each other, there is a method of determining the overlap using a ratio between the overlap amount and a text size.

For example, as a first condition,
in a case of γ/β>Th1 (here, Th1 is a predetermined first threshold value),
it is determined that there is an overlap.

As a second condition,
in a case of γ/α>Th2 (here, Th2 is a predetermined second threshold value),
it is determined that there is an overlap.

The determination may be performed by using only one of the first condition or the second condition, or the determination may be performed by using an AND condition or an OR condition of the first condition and the second condition.

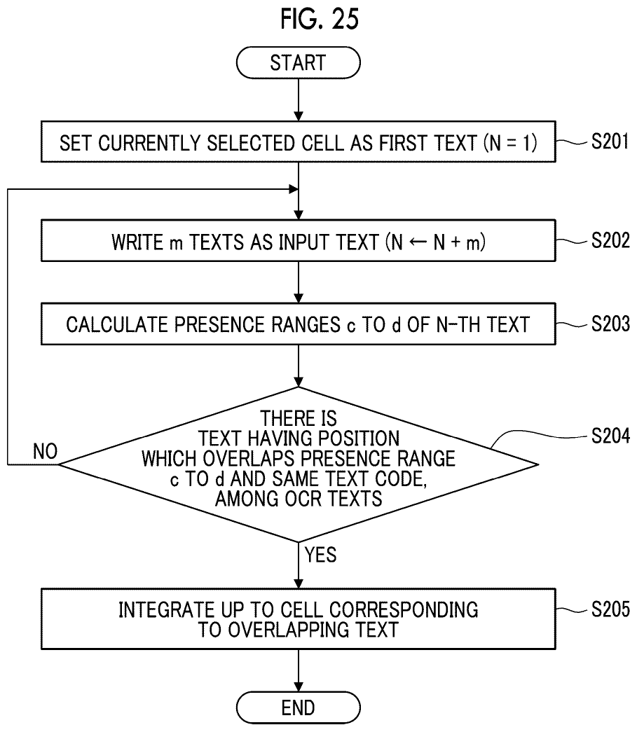

FIG. 25 is a flowchart illustrating a process related to cell integration for the automatic selection described above. The process illustrated in FIG. 25 is executed by the document management server 10 and/or the control unit 11 of the user terminal 30.

First, in cell integration executed by the control unit 11, calculation is started with the currently selected cell as the first text (N=1) (step S201). Next, m texts are written as input texts (N←N+m) (step S202). Next, presence ranges c to d of the N-th text are calculated (step S203). Thereafter, it is determined whether or not there is a text having a position which overlaps with the presence range c to d and the same text code, among OCR texts (step S204). In a case where this condition is satisfied (YES in step S204), the process is ended by integrating up to a cell corresponding to the overlapping text (step S205). On the other hand, in a case where the condition is not satisfied (NO in step S204), the process returns to step S202.

“m” in step S202 is typically “m=1”. Meanwhile, since a plurality of texts may be input at once, such as in a case of performing Kana-Kanji conversion, the number of input texts is denoted by “m”.

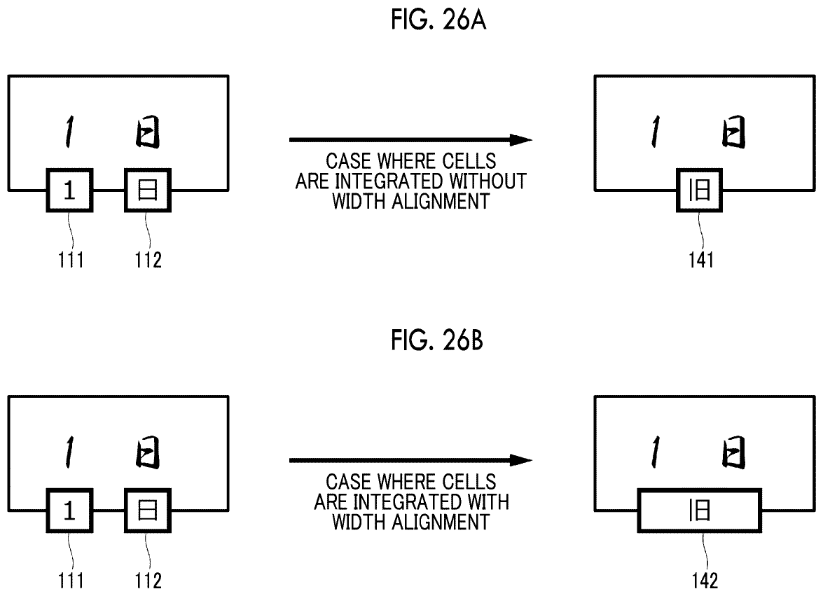

FIGS. 26A and 26B are diagrams describing a size of a cell after integration. In the example illustrated in FIG. 26A, a case where widths are not aligned and the cells are integrated is illustrated, and in the example illustrated in FIG. 26B, a case where the widths are aligned and the cells are integrated is illustrated.

In FIG. 26A, the cell 111 of “1” and the cell 112 of “ [symbol] ” are integrated, and an integrated cell 141 of “ [symbol] ” is formed by inputting a text of “ [symbol] ”. Meanwhile, since the integrated cell 141 of “ [symbol] ” is integrated without aligning the widths, it is difficult to understand which location in the image corresponds to the text of “ [symbol] ”.

On the other hand, in FIG. 26B, the cell 111 of “1” and the cell 112 of “ [symbol] ” are integrated by aligning the widths, and an integrated cell 142, which is a cell after the integration, is formed. The size (width) of the integrated cell 142 is the size (width) of a plurality of cells before the integration. Specifically, a rectangular shape of the cell of the integrated cell 142 is a bounding rectangle of the plurality of cells before the integration. As a result, it is easy to understand that the text of “ [symbol] ” corresponds to “1” and “ [symbol] ” in the image, and it is clear which image portions are integrated into one cell.

### Division of Integrated Cell

A cell after integration can also be configured to be divided by a predetermined operation. As a result, it is possible for a user to correct an erroneously integrated cell.

For example, the integrated cell is divided into cells before the integration by an operation performed on the integrated cell according to a predetermined rule, such as a specific key input. For example, a function of division is predetermined to a “Dell” key. Then, by operating the “Dell” key after the operation of integrating the cells, the cell is divided and restored to the state before the integration. In addition, the function of division is defined for an operation of inputting a “space”, and division is performed for a portion in which the space is input. In addition, the cell is restored and divided by an undo operation of restoring the cell by canceling the immediately preceding operation such as a shortcut key: Ctrl+Z. These operations are recorded as infinite undo, and the operation contents from a time of integration or a time of division are recorded one by one. Then, the configuration is provided such that a series of operations performed can be restored to a state before the operations are performed, and the integration and editing can be performed.

### Highlighting of Integrated Cell

It is also effective to highlight a cell after integration such that it is clear that the integration is performed. For example, the integrated cell is highlighted and displayed in a manner that distinguishes the integrated cell from a non-integrated cell, such as changing a background color, changing a color of a frame, and changing a thickness of a boundary of the frame. As a result, it is possible to make it easy for a user to understand which cells are integrated. For example, as described above, the cell after the integration can be divided, but the cell that is not integrated cannot be separated. The user can understand that the cell that is not highlighted cannot be divided. As a result, an unnecessary division process is not performed.

### Other Examples of Selection Method for Manual Selection

In the example described above, a cell is individually designated by manual selection in which the user selects the cells to be integrated. Here, a method of selecting cells to be integrated by another method that is not individually designated will be described.

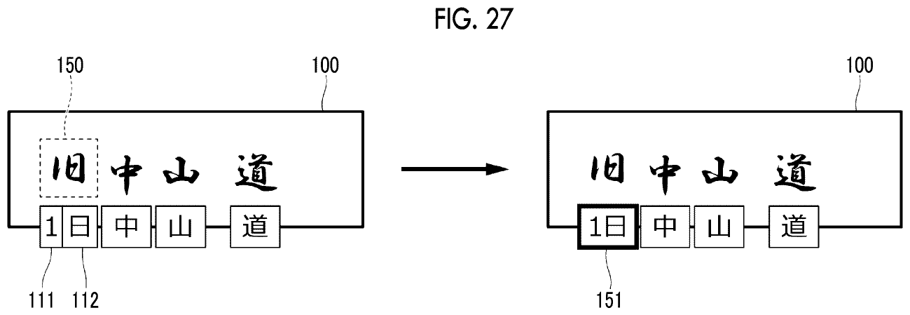

FIG. 27 is a diagram describing another selection method in a case of manual selection. In a case where it is required to correct the recognition result of the OCR process, for example, a plurality of cells can be integrated by surrounding the plurality of cells using a mouse. In the example illustrated in FIG. 27, by surrounding the text of “ [symbol] ” in the image text 100 with a rectangle 150, the cell 111 of “1” and the cell 112 of “ [symbol] ” are integrated to form an integrated cell 151. More specifically, in a case where the text of “ [symbol] ” is surrounded by a mouse, the text of “1” and the text of “ [symbol] ” are present in an image region surrounded by the rectangle, and thus the cell 111 of “1” and the cell 112 of “ [symbol] ” are integrated.

In addition, there are other methods as a method of selecting the cells to be integrated.

For example, in a case where a predetermined key is pressed, such as pressing “ctrl-a”, all the cells are integrated. The amount of operation of the user in a case where all the cells are to be integrated is reduced.

In addition, for example, in a case where a predetermined key is pressed, such as pressing “ctrl-3”, an example of integrating a plurality of cells at once, such as integrating a total of three cells including a selected cell and two right cells, is also included. The amount of operation of the user in a case where the plurality of cells are to be integrated is reduced.

Further, in a case where two cells are clicked, all the two cells and cells between the two cells are integrated. For example, in a case where “shift+” is clicked in addition to the cell currently being selected, a second cell can be selected. These two cells and cells interposed between these two cells can be set to a selected state or can be integrated.

In this manner, several methods are proposed here as a method of selecting cells to be integrated.

### Other Exemplary Embodiments

Here, still another exemplary embodiment will be described.

In the exemplary embodiment described above, “inputting text to be corrected after integrating cells” is performed. Here, a method of “deleting cell after inputting text to be corrected” will be described.

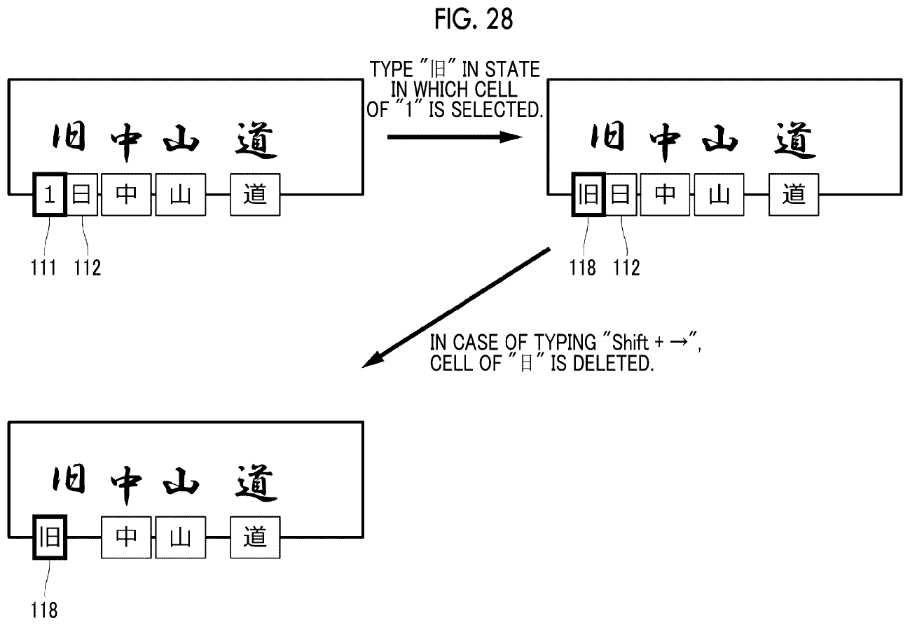

FIG. 28 is a diagram describing a method of deleting a cell after inputting a text. In the example illustrated in FIG. 28, in a state in which the cell 111 of “1” is selected, a user types “ [symbol] ”, and a cell 118 of “ [symbol] ” is formed at a position of the cell 111 of “1”. Thereafter, in a case where “shift+→” is pressed, the cell 112 of “ [symbol] ” is deleted, the cell 118 of “ [symbol] ” remains, and the correction is ended. It is possible to improve convenience of the user in the correction.

The present invention can also be applied to a program and a program product.

### Supplementary Notes

(((1)))

A document management system comprising:
a processor configured to:
   divide an image text for recognition into minimum units and display a recognition result in a cell for each of the minimum units at a display position in association with a position of the image text; and
   display a recognition result corrected by a user in an integrated cell obtained by integrating two or more cells.
(((2)))

The document management system according to (((1))),
wherein the integrated cell is obtained by integrating cells adjacent to and/or consecutive with a cell selected by the user.
(((3)))

The document management system according to (((2))),
wherein in a case where selection of a plurality of cells by the user is received, the selected cells are integrated.
(((4)))

The document management system according to (((3))),
wherein an input of a text by the user to the integrated cell is received and the text input by the user is displayed in the integrated cell.
(((5)))

The document management system according to (((3))),
wherein in a case where the user selects cells and inputs a text, the cells are automatically integrated, and the text input by the user is displayed in the integrated cell.
(((6)))

The document management system according to (((4))) or (((5))),
wherein a text of the recognition result described in the cell before the integration is deleted, and the text input by the user is displayed in the integrated cell.
(((7)))

The document management system according to (((2))),
wherein selection of one cell and an input of a text to the selected one cell are received by the user, and
in a case where a text identical to the input text is present in a cell of the recognition result of the image text, the one cell to the cell are integrated.
(((8)))

The document management system according to (((7))),
wherein in a case where the cells when the text is input to the one cell and a position of the text of the recognition result overlap with each other, the cells are integrated.
(((9)))

The document management system according to (((7))) or (((8))),
wherein a text of the recognition result described in the cell before the integration is deleted, and the text input by the user is displayed in the integrated cell.
(((10)))

The document management system according to any one of (((1))) to (((9))),
wherein a size of the integrated cell is the same as a size of a plurality of cells before the cells are integrated.
(((11)))

The document management system according to any one of (((1))) to (((10))),
wherein in a case where a predetermined operation is performed on the integrated cell, the integrated cell is divided.
(((12)))

The document management system according to any one of (((1))) to (((11))),
wherein the integrated cell is highlighted to inform that the cells are integrated.
(((13)))

A non-transitory computer readable medium storing a program causing a computer to execute:
a function of dividing an image text for recognition into minimum units and displaying a recognition result in a cell for each of the minimum units at a display position in association with a position of the image text; and
a function of displaying a recognition result corrected by a user in an integrated cell obtained by integrating two or more cells.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management system comprising:
a processor configured to:
divide an image text for recognition into minimum units and display a recognition result in a cell for each of the minimum units at a display position in association with a position of the image text; and
display a recognition result corrected by a user in an integrated cell obtained by integrating two or more cells.

2. The document management system according to claim 1,
wherein the integrated cell is obtained by integrating cells adjacent to and/or consecutive with a cell selected by the user.

3. The document management system according to claim 2,
wherein in a case where selection of a plurality of cells by the user is received, the selected cells are integrated.

4. The document management system according to claim 3,
wherein an input of a text by the user to the integrated cell is received and the text input by the user is displayed in the integrated cell.

5. The document management system according to claim 3,
wherein in a case where the user selects cells and inputs a text, the cells are automatically integrated, and the text input by the user is displayed in the integrated cell.

6. The document management system according to claim 4,
wherein a text of the recognition result described in the cell before the integration is deleted, and the text input by the user is displayed in the integrated cell.

7. The document management system according to claim 5,
wherein a text of the recognition result described in the cell before the integration is deleted, and the text input by the user is displayed in the integrated cell.

8. The document management system according to claim 2,
wherein selection of one cell and an input of a text to the selected one cell are received by the user, and
in a case where a text identical to the input text is present in a cell of the recognition result of the image text, the one cell to the cell are integrated.

9. The document management system according to claim 8,
wherein in a case where the cells when the text is input to the one cell and a position of the text of the recognition result overlap with each other, the cells are integrated.

10. The document management system according to claim 8,
wherein a text of the recognition result described in the cell before the integration is deleted, and the text input by the user is displayed in the integrated cell.

11. The document management system according to claim 9,
wherein a text of the recognition result described in the cell before the integration is deleted, and the text input by the user is displayed in the integrated cell.

12. The document management system according to claim 1,
wherein a size of the integrated cell is the same as a size of a plurality of cells before the cells are integrated.

13. The document management system according to claim 1,
wherein in a case where a predetermined operation is performed on the integrated cell, the integrated cell is divided.

14. The document management system according to claim 1,
wherein the integrated cell is highlighted to inform that the cells are integrated.

15. A non-transitory computer readable medium storing a program causing a computer to execute:
a function of dividing an image text for recognition into minimum units and displaying a recognition result in a cell for each of the minimum units at a display position in association with a position of the image text; and
a function of displaying a recognition result corrected by a user in an integrated cell obtained by integrating two or more cells.

16. A document management method comprising:
dividing an image text for recognition into minimum units and displaying a recognition result in a cell for each of the minimum units at a display position in association with a position of the image text; and
displaying a recognition result corrected by a user in an integrated cell obtained by integrating two or more cells.
